(19) United States
(12) Patent Application Publication
(10) Pub. No.: US 2026/0237739 A1
(43) Pub. Date: Aug. 13, 2026

(54) GEL ELECTROLYTE, PREPARATION METHOD THEREFOR AND SOLID-STATE LITHIUM BATTERY

(71) Applicant: Nankai University, Tianjin (CN)

(72) Inventors: Jun CHEN, Tianjin (CN); Donglei ZHAO, Tianjin (CN); Kaiwen SHI, Tianjin (CN); Tongrui ZHANG, Tianjin (CN); Zhenhua YAN, Tianjin (CN); Kai ZHANG, Tianjin (CN); Yong LU, Tianjin (CN); Yixin LI, Tianjin (CN); Weiwei XIE, Tianjin (CN); Haixia LI, Tianjin (CN)

(21) Appl. No.: 19/343,547

(22) Filed: Sep. 29, 2025

(30) Foreign Application Priority Data
Feb. 12, 2025 (CN) 202510154288.6

(51) Int. Cl. H01M 10/0565; H01M 10/052

(52) U.S. Cl. CPC H01M 10/0565; H01M 10/052; H01M 2300/0082; H01M 2300/0085

(57) ABSTRACT

The present application belongs to the technical field of new energy materials and devices, and relates to a gel electrolyte, a preparation method therefor and a solid-state lithium battery. A novel liquid initiator with a low freezing point, a cyclic ether-based polymerization monomer and a plasticizer are mixed to form a homogeneous phase precursor solution, the precursor solution is injected into a battery casing and stood at room temperature (20-35° C.) for in-situ polymerization, and the gel electrolyte-based solid-state battery can be obtained. Compared with the initiation of a common initiators, the gel electrolyte is initiated by the novel initiator, has better low-temperature performance, and forms a high-performance solid-state lithium battery.

### TECHNICAL FIELD

The present application belongs to the technical field of new energy materials and devices, and in particular to a gel electrolyte, a preparation method therefor and a solid-state lithium battery.

### BACKGROUND

Currently, most widely used liquid electrolytes carry risks of leakage and flammability. Therefore, developing high-safety lithium batteries with solid or quasi-solid electrolytes as the core is a necessary means for upgrading battery systems.

A gel electrolyte consists of a polymer matrix and a liquid-state plasticizer, and combines the advantages of all-solid-state electrolytes and liquid-state electrolytes. In the gel polymer electrolyte, the polymer matrix provides certain mechanical strength and flexibility, while the liquid-phase component can improve ionic conductivity and interface stability, and the polymer skeleton locks the organic liquid-phase component, such that the electrolyte is in a non-flowing gel state integrally, the leakage risk of the liquid-state electrolyte is avoided, and the gel polymer electrolyte is a solid-state electrolyte having the most application potential at the present stage. In-situ polymerization can ensure good contact between the solid electrolyte and both the positive and negative electrodes, forming ion pathways to match high-load positive electrodes, and is a highly promising method for preparing gel electrolytes.

However, although the ionic conductivity of many gel polymer electrolyte thin films can reach a level close to that of the liquid-state electrolyte (10⁻³ S cm⁻¹) at room temperature, under a low-temperature condition, the kinetics of Li⁺ slow down, the ionic conductivity of the gel polymer electrolyte decreases significantly, and the interfacial charge transfer rate reduces. Meanwhile, the organic liquid-phase component also has the possibility of solidification, such that the practical application requirement in a low-temperature environment is difficult to meet.

Therefore, it is particularly important to improve the low-temperature performance of the gel electrolyte in various ways.

There are two common methods for improving the low-temperature performance of the gel electrolyte. One is to improve the contact between electrodes and electrolyte interfaces by an in-situ polymerization method, accelerate the transmission rate of interfacial charges and avoid the low-temperature solidification of the organic electrolyte components, such that the rapid transportation of ions among liquid-phase molecules at low temperature is ensured. The other is to select an organic solvent with a lower freezing point as a plasticizer component. Researchers often combine the two methods to achieve superior low-temperature performance. At present, most domestic and foreign experts and scholars mostly choose to regulate and control the plasticizer component for study. However, in order to achieve the ideal low-temperature performance, excessive liquid-phase plasticizer needs to be added to the system (often requiring more plasticizer than the polymerization monomer), such as selecting to add a liquid phase plasticizer amounting to 150% of the cyclic ether-based monomer (DOL) usage, as reported to achieve excellent low-temperature performance at −20° C. (Ciucci et al, Advanced Energy Materials, 2022, 12, 2102). Such an excessive amount of liquid phase plasticizer will inevitably cause loss of energy density and may also lead to higher leakage risks and certain safety hazards.

### SUMMARY

The purpose of the present application is to overcome the deficiencies of the prior art and provide a gel electrolyte, a preparation method therefor and a solid-state lithium battery. The gel electrolyte with better low-temperature performance is prepared to be used for assembling a high-performance solid-state lithium battery.

The technical solution to realize the present application is as follows:

The first aspect of the present application is to provide a gel electrolyte, consisting of a polymerization monomer solution, an initiator and a plasticizer in a volume ratio of (50-300):(5-100): (0-100).

The polymerization monomer has a cyclic ether structure, the polymerization monomer solution is obtained by adding a lithium salt to the polymerization monomer, and/or the initiator is methyl difluoro(fluorosulfonyl)acetate (MDFSA).

The polymerization monomer is one or more selected from 1,3-dioxolane (DOL), 1,3,5-trioxane (TXE), ethylene oxide, propylene oxide, oxetane and tetrahydrofuran (THF); the lithium salt in the polymerization monomer solution is one or more selected from lithium bis(trifluoromethanesulfonyl)imide (LiTFSI), lithium difluoro(oxalate)borate (LiDFOB), lithium hexafluorophosphate (LiPF₆), lithium bis(fluorosulfonyl)imide (LiFSI), lithium tetrafluoroborate (LiBF₄) and lithium perchlorate (LiClO₄), and/or the concentration of the lithium salt is 0.1-10 mol/L.

The gel electrolyte is prepared by initiating in-situ polymerization of a cyclic ether-based monomer with a novel initiator, and has better low-temperature performance.

Further, the polymerization monomer solution, the initiator and the plasticizer are in a volume ratio of 100:(10-50):(30-70).

Preferably, the polymerization monomer solution, the initiator and the plasticizer are in a volume ratio of 100:30:(30-70).

Further, the plasticizer comprises a lithium salt and an organic solvent, and can be mixed with the polymerization monomer to form a homogeneous solution.

Further, the plasticizer is obtained by adding lithium bis(trifluoromethanesulfonyl)imide (LiTFSI) to fluoroethylene carbonate (FEC), and/or the concentration of lithium bis(trifluoromethanesulfonyl)imide is 0.5-3 mol/L.

The second aspect of the present application is to provide a method by mixing and dissolving a cyclic ether-based polymerization monomer, an initiator and a plasticizer to form a homogeneous phase precursor solution; and standing the precursor solution at 20-35° C. for 3 hours-48 hours to perform in-situ polymerization.

The third aspect of the present application is to provide a solid-state lithium battery comprising the gel electrolyte.

Further, the positive electrode of the solid-state lithium battery is any one of a lithium-rich manganese-based, a nickel-cobalt-manganese-based, lithium cobalt oxide and lithium-iron-phosphate, and/or a negative electrode is any one of a lithium metal, a lithium-based alloy, silicon carbon and graphite.

Further, a casing of the solid-state lithium battery is one of a pouch cell, a prismatic cell, a cylindrical cell, a stacking cell and a winding cell.

Preferably, the battery casing includes, but is not limited to a commercial XR2032 assembly battery, and/or the amount of the electrolyte precursor solution is 10 μL-100 μL.

The advantages and beneficial effects of the present application:
1. The present application develops the liquid-phase initiator with low-temperature performance. When the amount of liquid-phase component of the system is only 80% of the amount of the cyclic ether-based monomer (DOL), it also achieves excellent low-temperature performance at −20° C., greatly reducing the amount of the liquid-phase component in the gel electrolyte.
2. The present application initiates the ring-opening polymerization of the cyclic ether-based polymerization monomer by developing the novel liquid-state initiator with a lower freezing point. Under other conditions such as the plasticizer is consistent, the initiator has better low-temperature performance compared to commonly used initiators. Therefore, the preparation method is a highly promising preparation method for gel electrolytes applied in low-temperature solid-state batteries.

### BRIEF DESCRIPTION OF THE DRAWINGS

FIG. 1 is an optical photograph of the gel electrolyte after polymerization in Example 1;

FIG. 2 is a graph of infrared (FT-IR) spectroscopy tests of the gel electrolyte after polymerization in Example 1 and comparative samples of DOL+1 M LiTFSI, and FEC/1 M LiTFSI;

FIG. 3 is a graph of Raman spectroscopy tests of the gel electrolyte after polymerization in Example 1 and the comparative samples of DOL+1 M LiTFSI, and FEC/1 M LiTFSI;

FIG. 4 shows the ionic conductivity at different temperatures for an assembled SS-SS half-cell test of Example 1;

FIG. 5 shows charge-discharge curves of 3rd circle at room temperature and −20° C. in Example 2;

FIG. 6 shows charge-discharge curves of 3rd circle at room temperature and −20° C. in comparative Example 1; and

FIG. 7 shows the capacity versus cycle number graph at −20° C. in Example 2 (blue) and comparative example 1 (red).

### DETAILED DESCRIPTION OF THE EMBODIMENTS

The present application will be further illustrated by the accompanying drawings and specific examples. The following examples are given by way of illustration only and should not be construed to limit the scope of the present application. The protection scope of the present application is also not limited to the following examples.

### Example 1

1 M LiTFSI was firstly dissolved in a polymerization monomer (DOL), then 100 μL of the solution was taken out to be mixed and dissolved with 30 μL of MDFSA (novel initiator) and 50 μL of FEC/1 M LiTFSI (plasticizer) to form a homogeneous phase precursor solution;
the precursor solution in a vial was rested at room temperature (20° C.-35° C.) until in-situ polymerization was completed, an optical image of the gel electrolyte was obtained, and infrared (FT-IR) spectroscopy and Raman spectroscopy tests were performed on the gel electrolyte as well as comparative samples of polymerization monomer DOL+1 M LiTFSI and plasticizer FEC/1 M LiTFSI; and
the non-rested precursor solution in example 1 was subjected to half-cell assembly, with both the positive electrode and the negative electrode being stainless steel spacers (SS) to assemble an SS-SS half-cell, the amount of the precursor solution was 50 μL, and the cells were all stood for 24 hours at room temperature (20° C.-35° C.) after being assembled by using 0.85 ton of pressure until in-situ polymerization was completed, wherein a separator was Celgard 2500 and an injection tool was a pipette gun with a measuring range of 100 μL.

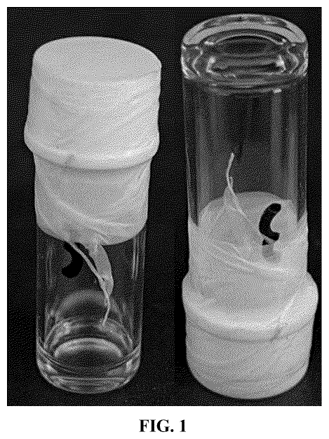

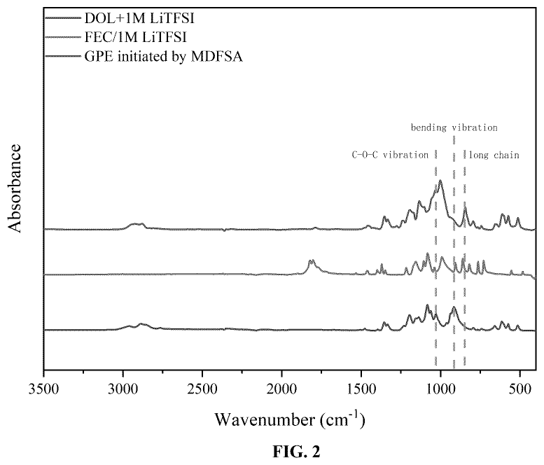

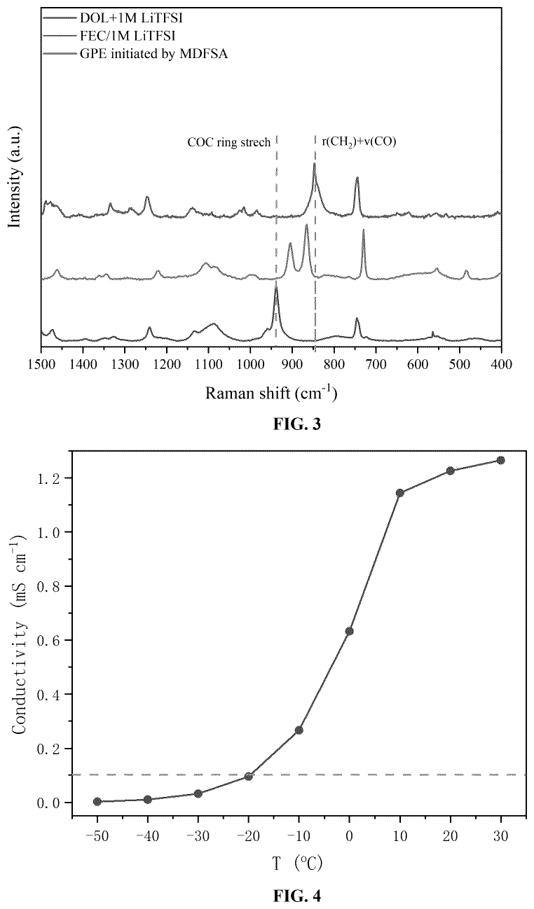

FIG. 1 showed the polymerization of the precursor solution in the vial of Example 1 after standing at room temperature for 24 hours, the flowing liquid in the vial turned into a gel state and cannot flow, indicating the completion of the polymerization reaction. FIG. 2 showed infrared (FT-IR) spectrums of Example 1 and the comparative samples (polymerization monomer and plasticizer). The characteristic peak of the monomer at about 915 cm⁻¹ disappeared, and the long-chain peak of the polymer at about 848 cm⁻¹ appeared, indicating the completion of the polymerization reaction. FIG. 3 showed Raman spectrums of Example 1 and the comparative samples (polymerization monomer and plasticizer). The C—O—C characteristic peak of the monomer at about 937 cm⁻¹ disappeared, and the characteristic peak of the polymer at about 845 cm⁻¹ appeared, also indicating the completion of the polymerization reaction. FIG. 4 showed an ionic conductivity test of the SS-SS half-cell from Example 1 at different temperatures after standing at room temperature for 24 hours, and the gel electrolyte still had the ionic conductivity of about 0.1 mS/cm at −20° C. and had a low-temperature operation potential.

### Example 2

1 M LiTFSI was firstly dissolved in a polymerization monomer (DOL), then 100 μL of the solution was taken out to be mixed and dissolved with 30 μL of MDFSA (novel initiator) and 50 μL of FEC/1 M LiTFSI (plasticizer) to form a homogeneous phase precursor solution; the non-rested precursor solution in Example 2 was subjected to cell assembly, the battery casing was a commercial XR2032 assembly battery, with the positive electrode being lithium iron phosphate and the negative electrode being a lithium metal, the diameter of the positive electrode of the full cell was 10 mm, the loading capacity was about 2 mg cm⁻², the negative electrode was a Li sheet with the diameter of 14 mm and the thickness of 450 μm, the amount of the precursor solution added was 50 μL, and the cell was stood for 24 hours at room temperature (20-35° C.) after being assembled by using 0.85 ton of pressure until in-situ polymerization was completed, wherein a separator was Celgard 2500 and an injection tool was preferably a pipette gun with a measuring range of 100 μL.

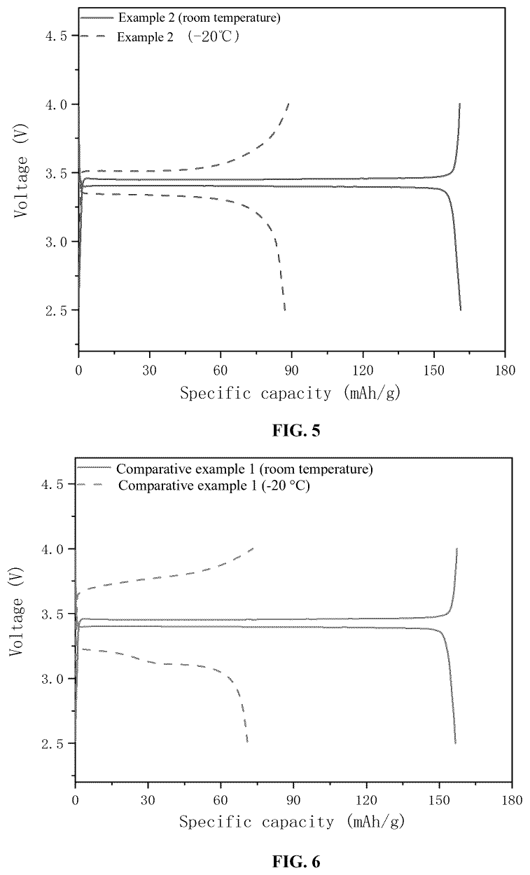

The assembled half-cell was activated at room temperature at 0.1 C and 2.5-4.0 V for 3 cycles, and then subjected to charge-discharge cycling at a low temperature of −20° C. at 0.1 C and 2.5-4.0 V, wherein 1 C=170 mAh g⁻¹. FIG. 5 showed charge-discharge curves of 3rd circle at room temperature and −20° C. in Example 2, wherein the discharge capacity of the 3rd cycle was 161.3 mAh g⁻¹ at room temperature, and the discharge capacity of the 3rd cycle was 87.1 mAh·g⁻¹ at −20° C., which was 54.0% of the capacity at the room temperature.

### Comparative Example 1

A method for preparing a cyclic ether-based gel electrolyte by using a common initiator is as follows: 1 M LiTFSI was firstly dissolved in a polymerization monomer (DOL), then 100 μL of the solution was taken out to be mixed and dissolved with 80 μL of FEC/1 M LiDFOB (plasticizer, meanwhile, LiDFOB can be used as an initiator) to form a homogeneous phase precursor solution;
the non-rested precursor solution in comparative example 1 was subjected to cell assembly, the battery casing was a commercial XR2032 assembly battery, with the positive electrode being lithium iron phosphate and the negative electrode being a lithium metal, the diameter of the positive electrode of the full cell was 10 mm, the loading capacity was about 2 mg cm⁻², the negative electrode was a Li sheet with the diameter of 14 mm and the thickness of 450 μm, the amount of the precursor solution added was 50 μL, and the cell was stood for 24 hours at room temperature (20° C.-35° C.) after being assembled by using 0.85 ton of pressure until in-situ polymerization was completed, wherein a separator was Celgard 2500 and an injection tool was preferably a pipette with a measuring range of 100 μL.

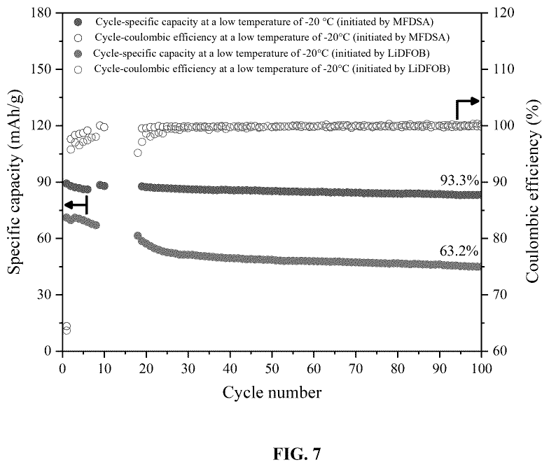

The assembled half-cell was activated at room temperature at 0.1 C and 2.5-4.0 V for 3 cycles, and then subjected to charge-discharge cycling at a low temperature of −20° C. at 0.1 C and 2.5-4.0 V, wherein 1 C=170 mAh g⁻¹. FIG. 6 showed charge-discharge curves of 3rd circle at room temperature and −20° C. in comparative Example 1, wherein the discharge capacity of the 3rd cycle was 156.7 mAh g⁻¹ at room temperature, and the discharge capacity of the 3rd cycle was 71.0 mAh·⁻¹1 at −20° C., which was only 45.3% of the capacity at the room temperature.

FIG. 7 showed cycle-capacity changes at −20° C. in Example 2 and comparative example 1. The capacity retention capacity at a low temperature of example 2 (100-cycle capacity retention rate was 93.3%) was significantly higher than that of comparative example 1(100-cycle capacity retention rate was 63.2%).

The above descriptions are merely preferred implementations of the present application. It should be noted that a person of ordinary skill in the art may further make several improvements and optimizations, including the improvements and optimizations to the cyclic ether-based polymerization monomer, the plasticizer, the lithium salt and the novel liquid-state initiator with a lower freezing point, without departing from the principle of the present application, but such improvements and optimizations should be deemed as falling within the protection scope of the present application.

1. A gel electrolyte, wherein the method for preparing the gel electrolyte comprises:
mixing and dissolving a polymerization monomer solution, an initiator and a plasticizer in a volume ratio of (50-300):(5-100):(0-100) to form a homogeneous phase precursor solution;
standing the homogeneous phase precursor solution at 20° C.-35° C. for 3 hours-48 hours to perform in-situ polymerization to obtain the gel electrolyte;
the polymerization monomer solution is obtained by adding a lithium salt to a polymerization monomer, and the polymerization monomer has a cyclic ether structure; and
the initiator is methyl difluoro(fluorosulfonyl)acetate.

2. The gel electrolyte according to claim 1, wherein the polymerization monomer is one or more selected from 1,3-dioxolane, 1,3,5-trioxane, ethylene oxide, propylene oxide, oxetane and tetrahydrofuran; the lithium salt in the polymerization monomer solution is one or more selected from lithium bis(trifluoromethanesulfonyl)imide, lithium difluoro(oxalate)borate, lithium hexafluorophosphate, lithium bis(fluorosulfonyl)imide, lithium tetrafluoroborate and lithium perchlorate, and/or the concentration of the lithium salt is 0.1-10 mol/L.

3. The gel electrolyte according to claim 1, wherein the plasticizer consists of a lithium salt and an organic solvent, and the lithium salt is one or more selected from lithium bis(trifluoromethanesulfonyl)imide, lithium difluoro(oxalate)borate, lithium hexafluorophosphate, lithium bis(fluorosulfonyl)imide, lithium tetrafluoroborate and lithium perchlorate, and/or the organic solvent is one or more selected from fluoroethylene carbonate, dimethyl carbonate, 1,2-dimethoxyethane and methyl propionate.

4. The gel electrolyte according to claim 3, wherein the plasticizer is obtained by adding the lithium bis(trifluoromethanesulfonyl)imide to the fluoroethylene carbonate, and/or the concentration of the lithium bis(trifluoromethanesulfonyl)imide is 0.5-3 mol/L.

5. A solid-state lithium battery comprising the gel electrolyte according to claim 1.

6. The solid-state lithium battery according to claim 5, wherein a positive electrode of the solid-state lithium battery is any one of a lithium-rich manganese-based, a nickel-cobalt-manganese-based, lithium cobalt oxide and lithium-iron-phosphate, and/or a negative electrode is any one of a lithium metal, a lithium-based alloy, silicon carbon and graphite.

7. The solid-state lithium battery according to claim 5, wherein a casing of the solid-state lithium battery is one of a pouch cell, a prismatic cell, a cylindrical cell, a l stacking cell and a winding cell.
